(19) United States
(12) Patent Application Publication
(10) Pub. No.: US 2011/0010404 A1
(43) Pub. Date: Jan. 13, 2011

(54) Device for collecting and managing documents and for controlling viewing thereof and method for using the device

(75) Inventor: Andrea Guglielmi, Este (IT)

Correspondence Address: MODIANO & ASSOCIATI, Via Meravigli, 16, Milano, 20123, IT

(73) Assignee: ONERING S.R.L.

(21) Appl. No.: 12/659,871

(22) Filed: Mar. 24, 2010

(30) Foreign Application Priority Data
Jul. 8, 2009 (IT) PD2009A000192

(51) Int. Cl. G06F 17/30; H04M 99/00; G06F 15/16

(52) U.S. Cl. 707/825; 379/93.02; 709/218; 707/E17.01

(57) ABSTRACT

A device for collecting and managing documents and for controlling the viewing of the documents, with a related method comprises a telephone for calling a predefined reference telephone number, associated with a desired document, an exchange for collecting the calls related to a plurality of predefined reference telephone numbers, each one associated with a predefined document or set of documents and loaded together with the corresponding document on a server, and a server, which is functionally interconnected with the exchange, is provided with a predefined user interface, is adapted to provide a user who has called one of the loaded predefined telephone numbers with the associated document or set of documents, counting how many users have called each reference telephone number.

The present invention relates to a device for collecting and managing documents and for controlling the viewing of such documents.

The present invention also relates to a method for using such device.

### BACKGROUND OF THE INVENTION

Currently, companies, whether they are manufacturing companies, or retail companies or service companies, use, in order to reach a considerable number of potential customers, various communication media, and among these there is increasing use of the worldwide network of computers known as the Internet and the World Wide Web service, which is accessed via the Internet, in addition to radio, television, newspapers, magazines, advertising billboards and the like.

By means of such set of communication media, companies communicate, through informational or advertising documents, with their potential customers, who however do not always have the possibility and the means to collect the documents and the information placed at their disposal, or to keep them tidily, except by resorting to their own memory, or to their own baggage in the case of leaflets and brochures.

Currently, the potential customer has various methods for managing the information that he receives, besides his own memory:
by means of traditional media, such as writing down the information on a paper medium,
by means of a computer-based platform, for example by adding a link of a Web page of interest to his list of favorites, or by entering such link in a site that manages (categorizes) his own favorites, or by writing down the same information On an electronic notepad of a personal computer,
by means of a mobile telephone, which can be used like a personal computer or can be used to directly call a telephone number, for example a toll-free number, if the latter is shown on the medium of the information of interest (for example a leaflet, an advertising billboard or a display or a caption during a television broadcast).

This type of solution, despite being widespread and appreciated, has some limitations, both for potential customers and for the companies that offer their products and services.

For a potential customer, these operations of writing down on paper, on a personal computer, on a mobile telephone or by calling on the telephone a number that might be given, require a relatively long processing time.

Moreover, while collecting a single item of information might take just a few seconds, rendering the same information structured and organized for example in a database from which it can be easily retrieved if needed is certainly far more costly.

The best-known and most frequently used tools for cataloging information are databases, which can be provided by means of the programs that are usually present in personal computers. The use of such programs requires inevitably the availability of a computerized device provided with a microprocessor suitable for the operation of such programs, i. e. a fixed or portable personal computer or other similar device, when the largest part of the population possesses at most a mobile telephone, which lacks the typical components of personal computers.

For a company that offers information there is a more complex problem, consisting in the substantial lack of feedback (return signal) regarding the effectiveness of its informational and advertising system.

Verification of the effectiveness of the system for publishing information and advertisements related to its products or services by a company would require expensive in-depth statistical studies, whose results would be delayed anyway with respect to the moment when they might be useful for modifying the informational or advertising campaign of the company.

### SUMMARY OF THE INVENTION

The aim of the present invention is to provide a device for collecting and managing documents and for controlling the viewing of such documents that makes it possible to obviate such limitations of the systems and devices of a known type for collecting information that have been used up to now.

Within this aim, an object of the invention is to provide a method for collecting and managing documents and for controlling the viewing of such documents that can involve all mass media, from radio to print to television to roadside advertising billboards and the like.

Another object of the invention is to provide a method that allows a potential customer of a company to rapidly and efficiently make a note of a product or a service of interest without the aid of a paper medium or a personal computer and without straining the memory of the user and potential customer.

Another object of the invention is to provide a method that allows a company to perform quick checks of its own advertising or informational campaigns.

Another object of the invention is to propose a device and a method for collecting and managing documents and for controlling the viewing of such documents that is structurally simple and easy to use, can be provided at low cost, and can be accessed cheaply and with known means.

This aim and these and other objects that will become better apparent hereinafter are achieved by a device for collecting and managing documents and for controlling the viewing of such documents, characterized in that it comprises
a telephone for calling a predefined reference telephone number, associated with a document that one wishes to view,
an exchange for collecting the calls related to a plurality of predefined reference telephone numbers, each associated with a predefined document or set of documents, and loaded together with the corresponding document on a server,
a server, which is functionally interconnected with said exchange, is provided with a predefined user interface, is adapted to provide a user who has called one of said loaded predefined telephone numbers with the associated document or set of documents, and has means for counting how many users have called each reference telephone number.

### BRIEF DESCRIPTION OF THE DRAWINGS

Further characteristics and advantages of the invention will become better apparent from the following detailed description of a preferred but not exclusive embodiment of the device according to the invention, shown schematically in its operation, by way of non-limiting example, in the accompanying drawings, wherein the sole FIGURE is a schematic view of the operation of the method according to the invention.

### DESCRIPTION OF THE PREFERRED EMBODIMENTS

With reference to the FIGURE, a device for collecting and managing documents and for controlling the viewing of such documents is generally designated by the reference numeral 10.

The device 10 comprises:
a telephone 11 for calling a predefined reference telephone number associated with a document that one wishes to view, such reference telephone number being loaded on a server, together with the associated document, by means of a predefined user interface,
an exchange 12 for collecting the calls related to a plurality of loaded predefined reference telephone numbers, each one associated with a predefined document or set of documents,
a server 13, which is functionally interconnected with the exchange 12, provided with the predefined user interface, is adapted to provide a user 14 who has called one of such loaded predefined telephone numbers with the associated document or set of documents, and is provided with means for counting how many users have called each reference telephone number.

In the diagram of the FIGURE, the documents available for viewing on the server 13 are designated by the reference signs 15, 15a and 15b, are three in number merely by way of example, and the corresponding reference telephone numbers are designated by N1, N2 and N3.

Such user interface consists of a Web site 16, which can be reached via the Internet and is shown in the FIGURE in schematic personal computer monitors 17 and 17a.

The first monitor 17 is referred to by an entity 18 interested in distributing or disseminating the documents 15 et seq.; the second monitor 17a is referred to by the calling user 14.

The counting means cited above are provided, for example, by a part of the software that manages the exchange 12.

A method for collecting and managing documents and controlling the viewing of such documents is also part of the invention.

Such method, which can be provided by using the device 10 according to the invention, consists of the following operations.

A first operation loads, by means of the adapted user interface, i.e., the Web site 16, a document 15, 15a and 15b, or a set of documents, on the server 13 and associates with such document a reference telephone number N1, N2 and N3 respectively.

Each one of the reference telephone numbers N1, N2 and N3 is made available to a user 14 who is potentially interested in viewing the document 15 and/or 15a and 15b.

Such first operation is to be performed by the entity 18 interested in distributing the documents 15, 15a and 15b.

The entity 18 can be for example a private company or a public body or any organization or association or a private individual.

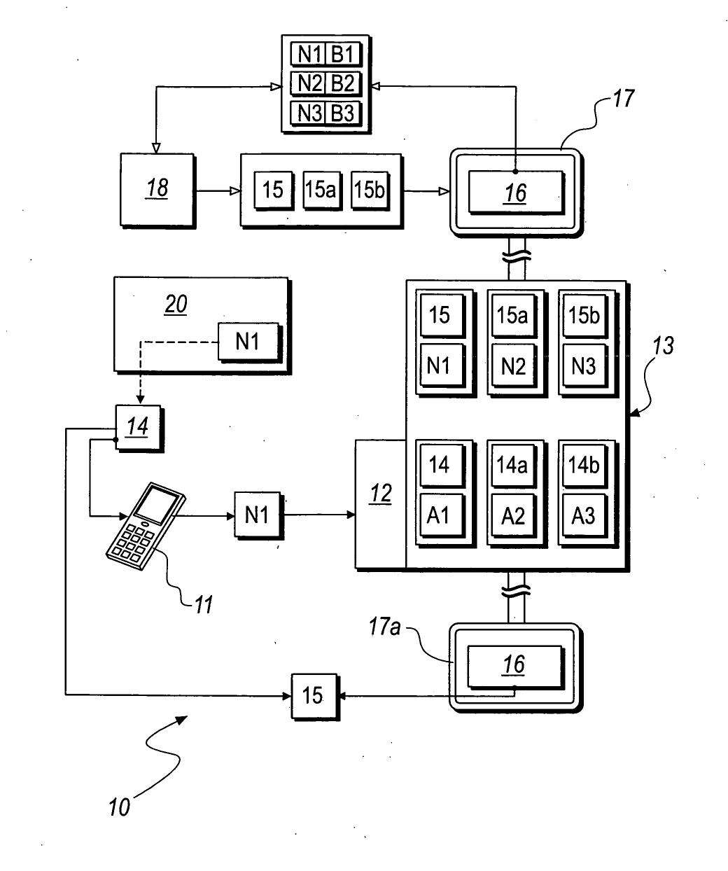

A second operation, which is not necessarily successive to the first one, stores on the server 13, by means of the user interface, i.e., the Web site 16, at least one telephone number, A1, A2, A3 in FIG. 1, and at least one address selected among a telephone number, an e-mail address and a mailing address, for the reception of a document or set of documents by a user 14, 14a or 14b who is potentially interested in viewing a document 15, 15a and 15b among the ones loaded on the server 13.

Each user registered on the server, the first user 14, the second user 14a, the third user 14b etcetera, is thus associated with at least one telephone number of his own A1, A2, A3 respectively, by means of which telephone number, termed caller, the user 14, 14a, 14b, also termed caller, contacts the server 13.

The server 13, by means of the Web site 16, is designed/enabled to transmit, for example, to the caller user 14, the document 15 associated with a reference telephone number N1, when this reference telephone number N1 is called by the user 14 by means of his telephone number A1 registered on the server 13.

The user interface is, as mentioned, a Web site 16, which is designed to provide a registered user 14, by means of associated software, with the document 15 for which the reference telephone number N1 has been called.

Such user interface, by means of the server 13 and the software loaded thereon, makes the document 15 available to the caller user 14, by means of at least one method selected among
delivery via e-mail to an e-mail address made available by the registered user 14,
telephone contact with a telephone number made available by the user 14,
entry of the document 15 in a customizable database made available to the user 14 by the Web site 16.

An exchange 12 is associated with the server 13, as mentioned, and is designed to record the number of the caller user 14 and subsequently end the call after a predefined number of rings, preferably one ring.

The server 13 is designed/enabled to perform the following operations:
storing a telephone number A1, A2, A3 of a user 14, 14a, 14b and assigning an identification name thereto,
storing a document 15, 15a, 15b or set of documents and a corresponding associated telephone number N1, N2, N3 respectively,
associating with each document 15, 15a, 15b or set of documents a corresponding tag (a code adapted to facilitate indexing in Internet search engines) or a category to which it belongs, in order to catalog the documents,
storing the calls made by the registered users 14, 14a, 14b,
for each call of the users, making available to the user who made the call the document 15, 15a, 15b or set of documents with which the called reference telephone number N1, N2, N3 is associated,
counting the calls received by each reference telephone number N1, N2, N3.

Then the exchange, with the help of the counting means, associates with each reference telephone number N1, N2, N3 the number of times that, at the time when the check is performed, a number B1, B2, B3, respectively, related to how many times the corresponding reference telephone number has been called.

The server 13, by means of the Web site 16, or with another equivalent method, is designed/enabled to make the numbers B1, B2, B3 that count the calls received by each reference number N1, N2, N3 available to the entity 18 that loaded the documents 15, 15a, 15b, to which the reference telephone numbers N1, N2, N3 are correlated, on the server 13.

In this manner, the entity 18 interested in distributing the documents 15 et seq. knows the actual distribution of such documents by means of the server 13.

The exchange 12 is designed to store the moment when a call of a reference telephone number N1 et seq. by a user 14 is received.

The Web site 16 is designed to send, by means of the associated software, informational SMS messages to calling telephone numbers that are not registered on the server 13.

An example of operation of the device 10 and of the method according to the invention is as follows.

A newspaper or a magazine prints at the bottom of each one of the articles or pieces of writing that are present therein a reference telephone number, for example N1.

FIG. 1 illustrates schematically the page of a magazine 20 that bears a reference telephone number N1.

The publisher of the magazine loads on the server 13, by means of the Web site 16, the document 15, which contains the article or the piece of writing that is present on the page of the magazine 20, and associates the reference telephone number N1 with it.

A user 14, who has registered and loaded on the server 13, by means of the Web site 16, a caller telephone number A1 of his own, can call, if he is interested, by means of his mobile telephone 11 the number N1 seen on the page of the magazine 20.

The call is received and recorded by the exchange 12, and the software loaded on the server 13 counts such call in the number B1 of calls received by the reference number N1.

At the same time the software arranges for the document 15, which contains the article carried on the page of the magazine 20, to be sent via e-mail or ordinary mail or in another similar and equivalent way to an address registered by the same user 14.

A second example of operation of the device 10 and of the method according to the invention is as follows.

A radio station broadcasts a signal that causes the display of a reference telephone number, for example N1, on the monitors of radios and car radios that also have such scrolling text function.

The radio station loads on the server 13, by means of the Web site 16, documents 15, 15a etcetera that contain references and information related to the broadcasts, associating with its own frequency a reference telephone number N1, and with each document 15, 15a etcetera a program broadcast time.

A user 14, who has registered and loaded on the same server 13 by means of the Web site 16 a caller telephone number A1 of his own, can call, if he is interested, by means of his mobile telephone 11, the number N1 read on the monitor of his own radio and car radio.

The call is received and recorded by the exchange 12, and the software loaded on the server 13, in addition to counting such call in the number B1 of calls received by the number of reference N1, also records the time of reception.

At the same time, the software arranges for the document 15, or 15a etcetera, which is related to what had been broadcast by the radio station at the time when the user 14 dialed the reference number N1, to be sent via e-mail or regular mail or in another similar and equivalent way to an address registered by the same user 14.

In practice it has been found that the invention achieves the intended aim and objects.

Particularly, by means of the invention a device and a method have been devised for collecting and managing documents and controlling the viewing of such documents, which can involve all mass media, from radio to print to television to roadside advertising billboards and the like.

Moreover, by means of the invention a method has been devised which allows a user who is a potential customer of a company to rapidly and effectively make a note of a product or service of interest without the aid of a paper medium or a personal computer and without straining the memory of such user and potential customer.

Moreover, the invention has provided a method that allows an entity interested in distributing its own documents, for example a company, to perform quick checks of its own advertising or informational campaigns.

Moreover, the invention has proposed a device and a method for collecting and managing documents and controlling the viewing of such documents that is structurally simple and easy to use, can be provided at low cost and is accessible cheaply and with known means.

The invention thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. PD2009A000192 from which this application claims priority are incorporated herein by reference.

What is claimed is:

1. A device for collecting and managing documents and for controlling viewing of said documents, comprising
a telephone set suitable for making a call to a predefined reference telephone number, associated with a document that one wishes to view,
an exchange for collecting calls related to a plurality of predefined reference telephone numbers, each reference telephone number associated with a predefined corresponding document or set of documents,
a server, which is functionally interconnected to said exchange and on which each said reference telephone number is loaded with the corresponding document, said server being provided with a predefined user interface, being adapted to provide a user who has called one of said loaded predefined reference telephone numbers with the associated document or set of documents, and comprising counting means for counting how many users have called each reference telephone number.

2. The device of claim 1, wherein said user interface consists of a Web site that can be reached via the Internet.

3. A method for collecting and managing documents and for controlling viewing of said documents, which consists in:
loading on a server, by way of an adapted user interface, a document, or set of documents, and associating with said document, or set of documents, a reference telephone number, which is adapted to be made available to a user who is potentially interested in viewing said document or set of documents, wherein said loading step is performable by a subject interested in distributing documents;
registering on the server, by way of the user interface, at least one personal telephone number and at least one personal address selected among a telephone number, an e-mail address and a regular mail address, in order to receive at said telephone number and/or e-mail address and/or regular mail address a document or set of documents, and wherein said server registration step is performed by a user potentially interested in viewing a document or set of documents,
enabling said server to transmit by way of said user interface to the user the document, or set of documents, associated with a said reference telephone number, when said reference telephone number is called by the user by way of a personal telephone number registered on said server.

4. The method of claim 3, comprising providing said user interface as a Web site, which is designed to make available to said registered user, by way of an associated program, said document, or set of documents, by way of at least one of a:
delivery via e-mail to an e-mail address made available by a subscribed user,
telephone contact with a telephone number made available by a subscribed user,
loading of said documents in a customizable database made available to said user by said Web site.

5. The method of claim 3, comprising providing an exchange associated with the server and suitable to record the number of the caller user and then end the call after one ring or a predefined number of rings.

6. The method of claim 5, comprising enabling said server to perform the following:
storing a telephone number of a user and assigning an identification name thereto,
storing a document or set of documents and a corresponding associated telephone number,
associating with each document, or set of documents, a corresponding tag comprising a code that is adapted to facilitate indexing in Internet search engines, or a category to which it belongs, in order to catalog the documents,
storing the calls made by users,
for each user call, making available to the user who made the call the document, or set of documents, with which the called telephone number is associated,
counting the calls received by each reference telephone number.

7. The method of claim 6, comprising enabling the Web site to store a moment when a call is received from a user of a telephone number associated with a product, a service or other user desired entity.

8. The method of claim 7, comprising further enabling said Web site to send informational SMS messages to non-subscribed and not-registered caller telephone numbers.
